(19) United States
(12) Patent Application Publication
(10) Pub. No.: US 2025/0167327 A1
(43) Pub. Date: May 22, 2025

(54) PROCESS OF MATERIALS RECOVERY FROM ENERGY STORAGE DEVICES

(71) Applicant: MINIMINES CLEANTECH SOLUTIONS PRIVATE LIMITED, Jaipur (IN)

(72) Inventors: Anupam Kumar, Bokaro (IN); Arvind Bhardwaj, Jaipur (IN)

(21) Appl. No.: 18/727,083

(22) PCT Filed: Jan. 6, 2023
(86) PCT No.: PCT/IN2023/050013

§ 371 Date: Jul. 6, 2024

(30) Foreign Application Priority Data
Jan. 7, 2022 (IN) 202111040571

(51) Int. Cl. H01M 10/54; C01B 32/05; C01D 5/16; C01D 5/18; C01D 15/02; C01D 15/08; C01G 45/01; C01G 51/01; C01G 53/01

(52) U.S. Cl. CPC H01M 10/54; C01B 32/05; C01D 5/16; C01D 5/18; C01D 15/02; C01D 15/08; C01G 45/01; C01G 51/01; C01G 53/01

(57) ABSTRACT

Process of materials recovery from energy storage devices, wherein the process comprises cleaning, washing, deep discharging and then crushing the devices to recover floating non-magnetic materials and magnetic materials. Further the black mass is treated with baking process, water soaking process, gravity filtration process, leaching process, Cobalt salt recovery process, Manganese salt recovery process, Nickel salt recovery process, Sodium salt recovery process, Lithium salt recovery process and then selective absorption of respective ions using Ion-exchange resin and liquid-liquid extraction using organic solvent for beneficiation to recover pure Cobalt ions, Manganese ions, Nickel ions and Lithium ions. Further the process of the present invention facilitates in recovering all possible battery grade materials from used energy storage devices. The process of the present invention uses less water, energy, economical, safe, environment friendly without generating any hazardous gases while the process has very low carbon foot prints.

### CROSS-REFERENCE TO RELATED APPLICATIONS

This application claims priority from Indian Patent Application number 202111040571, entitled “PROCESS OF MATERIALS RECOVERY FROM ENERGY STORAGE DEVICES”, filed on Jan. 7, 2022, which application is hereby incorporated herein by reference in its entirety.

### FIELD OF THE INVENTION

The invention generally relates to the field of recycling of energy storage devices, and more particularly it relates to a process of recovery of materials from used energy storage devices such as batteries.

### BACKGROUND OF THE INVENTION

The following background information may present examples of specific aspects of the prior art (e.g., without limitation, approaches, facts, or common wisdom) that, while expected to be helpful to provide additional aspects of the prior art, is not to be construed as limiting the present invention, or any embodiments thereof, to anything stated or implied therein or inferred thereupon.

Energy storage devices such as lithium ion/sodium ion batteries, Metal-air batteries, super capacitors or the like have revolutionized technical advances in electric transportation, electronic devices, biomedical devices, renewable energy devices, grid energy networks, all-electric aircraft, space exploration and wherever electric energy storage is required. About 1.6 million metric tons of spent lithium-ion batteries and/or packs are estimated to be disposed of by 2030 globally due to exponential growth in the electric vehicle segment by 2030. Currently, more than 95% of lithium-ion batteries end up in landfills, without proper dumping regulations, creating serious environmental concerns. To encourage the recycling of lithium-ion batteries and packs, industry standards and environmental regulations have been developed.

Used or waste or recyclable lithium-ion batteries, sodium ion batteries and other energy storage devices or packs contain materials such as cobalt, nickel, lithium, aluminum, copper, graphite, magnesium, manganese, titanium, scandium, lanthanum, cerium, etc. Therefore, used batteries, power banks and other energy storage devices and/or packs have been considered a significant urban mining source of lithium and other important materials used in the batteries and other energy storage devices.

Conventionally, pyrometallurgy or smelting methods are used to recycle energy storage devices, for example, lithium ion or sodium ion batteries. But these methods generally recover only metals. In the pyrometallurgy process, lithium is lost in the slag and thus recovery of lithium is economically not viable by the known process.

Numerous attempts have been made and several prior art devices are known for recycling and recovery of materials from energy storage devices. Even though these innovations may be suitable for the specific purposes to which they address, however, they would not be as suitable for the purposes of the present invention.

For example, U.S. Pat. No. 7,964,299 to Hashimoto discloses a method of recycling a battery that includes a plurality of lithium cells removable from one another, wherein the internal resistance of the lithium cells was measured, wherein the lithium cells having the operational level less than the predetermined level of operational capability are replaced with new lithium cells as the battery is re-assembled. The removed lithium cells are recycled by separating first metal second metal by grinding the with a fluid in a mixer forming; and re-using the lithium cells of another of the recycling categories in an application differing from their original application, wherein the lithium cells of another of the recycling categories are unusable in their original application.

For example, U.S. Pat. No. 9,450,277B2 to Dunagan et al. discloses a systems and methods for the recycling of lithium-ion batteries or the like by comminution, neutralization and destruction of used batteries, controlling the explosive reaction of the battery components during processing, and processing the materials into a suitable form for sampling and recycling.

For example, U.S. Pat. No. 10,522,884B2 to Yan Wang et al. teaches about a method for recycling lithium-ion batteries, comprising: identifying a molar ratio for cathode materials for a recycled battery; forming a leach solution by combining crushed battery material from a lithium battery recycling stream with an acidic leach agent and hydrogen peroxide to separate cathode materials from undissolved materials; filtering the undissolved materials from the leach solution to leave dissolved salts of cathode materials remaining in the leach solution; determining a composition of the leach solution of the cathode material salts dissolved therein; adding, at least one of Ni, Co, Mn, or Al salts in a sulfate or hydroxide form to adjust the molar ratio of the dissolved cathode material salts in the leach solution to correspond to the identified molar ratio for the recycled battery, including adding a solution of aluminum sulfate and a chelating agent to the leach solution; and raising the pH of the leach solution to at least 10 for precipitating and filtering metal ions of the cathode materials to form a charge material precursor by coprecipitating the Ni, Co, Mn and Al salts remaining in the leach solution as a combined hydroxide or carbonate having a molar ratio corresponding to the identified molar ratio for the recycled battery, the charge precursor material responsive to sintering for forming active cathode materials in an oxide form following sintering with lithium carbonate (Li2CO3).

For example, Chinese patent CN109652655B to Zhou Minghao relates to a method for recovering lithium in a lithium battery recovery and treatment process. Mechanically crushing the waste lithium battery cell, soaking after crushing, pyrolyzing filter cake fragments after water immersion and filtration to obtain a pyrolysis material, then soaking in water under stirring, filtering and screening while hot to obtain copper-aluminium foil mixed fragments, a positive-negative electrode mixed filter cake and a lithium-rich solution; repeatedly soaking the filtrate in water after the obtained lithium-rich solution is subjected to stirring water leaching and filtering of the pyrolysis material, then heating the lithium-rich solution, separating out lithium carbonate by utilizing the solubility difference, and filtering to obtain a crude lithium carbonate product; preparing lithium carbonate slurry from the crude product by water, pumping the slurry into a liquid jet circulation reactor, and filtering out precipitates to obtain a refined lithium solution; and heating the refined lithium solution, preserving heat, filtering, washing a filter cake with water, drying the filter cake, and obtaining a lithium carbonate product. By adopting the method for recovering lithium from waste lithium batteries, the purity of the recovered lithium carbonate is over 99.5 percent, and the impurity index can reach the industrial standard of the use of battery-grade lithium carbonate.

For example, Chinese patent CN109652655B to Chen Minghai discloses a method for recycling spent lithium-ion batteries to manufacture NCM salt (a sulfate mixture containing nickel, cobalt and manganese). The process comprises the steps of crushing, pyrolyzing, sorting, leaching, purifying, dosing and crystalizing. The method results no soluble alkali metal ions (such as potassium and sodium), thus water recycling can be realized, wastewater zero discharging is realized, and a lot of water resources are saved; on the other end, after a purification liquid is dosed, a certain proportion of NCM salt is obtained by utilizing a crystalizing principle, so that an extraction/recovery process is avoided in the process, and the generation of a lot of wastewater and waste gas is avoided. In addition, the NCM slat provided by the invention can be used as a raw material for producing a precursor, and according to a proportion requirement of the precursor material, bits of nickel sulfate, cobaltous sulfate and manganese sulfate are used for adjusting so as to accomplish the preparation before precursor synthesis, so that the process is simplified, and meanwhile, the production efficiency is improved.

For example, Chinese patent CN107419096A to Xu Xiaofci et al. discloses a method for preparing a renewable ternary anode material by recovering waste lithium batteries and belongs to the technical field of resource recycling. The method comprises the steps that acid leaching is performed with organic acid; after copper, aluminum and iron are removed, a ternary material precursor is obtained through co-precipitation under an alkaline condition; and the ternary material precursor and lithium carbonate are ball-milled and calcined, so that the renewable ternary anode material is obtained. According to the method, the recovering rate of nickel is 98.57-98.66%, the recovering rate of cobalt is 99.63-99.72%, the recovering rate of manganese is 99.91-99.94%, the copper-iron-aluminum removal rate is 99.94-99.96%, the first reversible charging and discharging efficiency of the renewable ternary anode material is 90% or over, the heavy metals in the waste lithium batteries are recovering, and accordingly the pollution to the environment and harm to physical health of human beings are reduced.

One of the disadvantages is that conventional processes require a lot of energy and are dependent on use of high external energy.

Another disadvantage associated with the methods and systems known in the prior art is that conventional systems and methods are not efficient and the efficiency of conventional systems and methods is not efficient enough as of the present invention, in terms of energy saving zero waste, low carbon foot print, individual material separation to highest purity.

Yet another disadvantage associated with the methods and systems known in the prior art is that conventional systems and methods are not environmentally friendly as the conventional systems and methods generate emissions of hazardous gases due to high-temperature combustion.

Yet another disadvantage associated with the methods and systems known in the prior art is that conventional systems and methods are batch processes and takes a lot of time to extract just one elemental compound. The whole process requires to be done in a single container and either molarity or composition testing of mixed solution is required after each step, which adds more processing time.

Still another disadvantage associated with the methods and systems known in the prior art is that recovery efficiency of electrode materials as per conventional systems and methods are less efficient as except nickel and cobalt, the rest of the materials get burnt in the process.

A further disadvantage associated with the methods and systems known in the prior art is that the material except nickel and cobalt are converted to gaseous products and thus enhances Green House Gases (GHGs) which are injurious to the environment.

It is apparent now that numerous innovations that are adapted to a variety of methods and systems used for recovery of material form used energy storage devices which have been previously developed in the prior art that are adequate for various purposes. Furthermore, even though these innovations may be suitable for the specific purposes to which they address, accordingly, they would not be suitable for the purposes of the present invention as heretofore described to be used in all resources/material recovery from used storage devices. Thus, an environment friendly and highly efficient process for recovery of materials from used energy storage devices such as batteries is needed.

### SUMMARY OF THE INVENTION

The purpose of the present invention is to provide a process that is sustainable extraction or recovery of materials from energy storage devices and their components. This process is designed for the recycling of lithium-ion/sodium-ion batteries supercapacitors, ultracapacitors and metal air batteries or the like irrespective of their chemical composition, chemistry, size or shape. The present invention further configured to be used to recover materials from any form of electronic wastes including PCB boards, micro-chips, circuit boards or the like. According to an exemplary embodiment of the present invention, a process of recovery or extraction of battery-grade metal salts of Nickel, Cobalt, Lithium, Manganese, Copper, etc. along with spherical graphite, carbon, electrolyte with optimum purity is achieved. The recovered materials using the process suggested in the present invention allows to significantly lower carbon-footprint, with 99% purity of the metal ions and commercially viable for reuse in battery manufacturing and other industrial application with very low carbon foot prints.

The present invention allows to overcome the above-mentioned conventional problems of the prior arts; therefore, it is an object of the present invention is to provide a process of extraction/recovery of materials from used energy storage devices, for example, lithium ion, sodium ion, metal-air batteries and/or other energy storage devices, battery packs and obviates the disadvantages associated with the methods and system known in the prior art.

Another object of the present invention is to provide a process of extraction/recovery of used materials from energy storage devices, which is capable to work at minimum energy preferably renewable energy sources and thus the carbon footprint is minimized.

Yet another object of the present invention is to provide a process of extraction/recovery of used materials from energy storage devices, which is an environment-friendly mechanochemical process which uses minimal energy and water to separate polymer packaging, metallic components, black matter/mass, etc. from spent or after-life lithium-ion, sodium-ion, and metal-air energy storage devices.

Yet another object of the present invention is to provide a process of extraction/recovery of used materials from energy storage devices, having more than 90% recovery efficiency for the materials such as cobalt, nickel, lithium, copper, aluminum, graphite, etc. in their pure form.

Still another object of the present invention is to provide a process of extraction/recovery of used materials from energy storage devices, which is environment friendly and does generate emissions of hazardous gases.

Another object of the present invention is to provide a process of extraction/recovery of used materials from energy storage devices, which is capable to recover material other than nickel and cobalt as the other material does not burn and convert into gases and therefore reduces the generation of Green House Gases (GHGs).

Yet another object of the present invention is to provide a process of extraction/recovery of used materials from energy storage devices, to recover battery grade materials including metals and non-metals for use in the manufacture of lithium ion/sodium ion-based energy storage devices and/or packs for the automotive sector (electric vehicle).

Still another object of the present invention is to provide a process of extraction/recovery of used materials from energy storage devices, for optimum recovery of cobalt, nickel, lithium, copper, aluminum, graphite, etc.

A further object of the present invention is to provide a method of extraction/recovery of used materials from energy storage devices which is environment friendly and is useful for the recovery of black matter/mass from Lithium ion, Sodium ion, and metal-air energy storage devices and/or packs or battery scrap.

Another object of the present invention is to provide an environment friendly method useful for the recovery of oxides of Cobalt, Nickel, Lithium, Copper, Aluminum, Graphite, etc. from the extracted black matter/mass.

Yet another object of the present invention is to provide an environmentally friendly method useful for the recovery of sulfates of Cobalt, Nickel, Lithium, Copper, Aluminum, Graphite, etc. from the extracted black matter/mass.

Still another object of the present invention is to provide an environment friendly method useful for the recovery of the carbonates of Cobalt, Nickel, Lithium, Copper, Aluminum, Graphite, etc. from the extracted black matter/mass.

A further object of the present invention is to provide an environment friendly method for the recovery of polymeric binder from the black material/mass extracted from lithium ion, sodium ion and metal-air energy storage devices, battery or the like.

Yet another object of the present invention is to provide an environment friendly mechanochemical process for the removal of Aluminum, Copper and Nickel metal current collectors either in sheet or mesh form from li-ion, sodium-ion, metal-air batteries and/or energy storage devices scrap.

Yet another object of the present invention is to provide an environment friendly mechanochemical process for the removal of electrode separators either in continuous sheet or small pieces form from li-ion, sodium-ion, metal-air energy batteries and energy storage devices scrap.

Another object of the present invention is to provide an environment friendly method capable to extract/recover battery grade materials, from lithium ion, sodium ion, metal-air batteries and/or energy storage devices/packs scrap, with minimal use of water in the process.

Yet another object of the present invention is to provide an environment friendly method to recover battery grade materials in a stable state, and economically sustainable manner with low carbon foot prints. Further the process of the present invention allows no liquid or gaseous discharge to the environment. Water used in the process is reused for subsequent processing and recovery process. Further the present invention uses heat from the heat bank that was stored from the exothermic reaction for the process where heat is required.

Yet another object of the present invention is to provide a unique turnkey multi-stage reactor system which uses gravity to transfer the materials from one chamber to the next chamber reducing the energy consumption and making the process environment friendly. (Each step separates one elemental compound from the black mass)

A further object of the present invention is to provide a unified and environment friendly method capable of deactivating, recovering and regenerating cathode and anode material from energy storage devices, in particular, rechargeable and flow energy storage devices.

According to an aspect of the present invention, the process of recovery is configurable for separation of plastic packaging, metals casing, polymeric separators, metallic current collectors, black mass and extraction of metallic and non-metallic materials, according to the battery chemistry, composition and physical form factor.

According to another aspect of the present invention, the present invention is economical as the process requires less manual intervention, further it is flexible as it can be controlled remotely. Further the present invention can be easily configured to be automated by the help of AI based sensor control systems. Further, the process of the present invention doesn't require expensive additives and extractants for the recovery of metal salts.

The present invention is eco-friendly as it uses natural gravity for the transfer and filtration of liquids, semi solids and solids and uses magnetic separation for removing magnetic materials.

The present invention is compatible with any type of Lithium-ion/metal-ion/sodium ion batteries irrespective of their chemical chemistries and composition and process is compatible with any type of climatic conditions.

The present invention can be performed under minimal space/area and the process is less time-consuming with less power and water consumption.

These and other objectives, advantages and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### DETAILED DESCRIPTION OF THE INVENTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific system and processes described in the following specification, are simply exemplary embodiments of the inventive concepts defined in the appended claims. Throughout this specification the word “comprise” or variations such as “comprises or comprising”, will be understood to imply the inclusions of a stated element, integer or step, or group of elements, integers or steps, but not the exclusions of any other element, integer or step or group of elements, integers or steps. Specific dimensions and other physical characteristics relating to the embodiments disclosed herein are therefore not to be considered as limiting, unless the claims expressly state otherwise.

According to several embodiment of the present invention, a process of recovery, restoration and/or extraction of materials from energy storage devices, for example, lithium ion, sodium ion, metal-air batteries and/or other energy storage devices/packs are herein described with numerous specific details so as to provide a complete understanding of the invention.

According to an aspect of the present invention, a process of recovery of materials from used batteries, wherein the process comprises: a) air cleaning and then washing the batteries with water; b) deep discharging the cleaned and washed batteries in a deep discharging solution then air dried to remove surface moisture; c) chopping and crushing the discharged batteries in an airtight crusher at 50° C.-85° C. to obtain crushed material, powdered black mass and volatile organic electrolyte material that is collected in an electrolyte collector using condensation; d) separating magnetic materials, non-magnetic materials, copper and aluminum from the crushed material; c) baking the remaining non-magnetic crushed material and the black mass; f) dispersing the baked material and the black mass in deionized water to form a Lithium contained solution, separating floating plastic wastes over the solution and then filtering the dispersed black mass from the Lithium contained solution; g) heating the Lithium contained solution to obtain Lithium hydroxide powder; h) acid leaching the black mass with an acid, an oxidising agent and deionized water to obtain a first solution with carbon precipitate, wherein the carbon precipitate is dried to recover carbon powder; i) mixing the first solution with alkali solution to form a second solution of pH value 8 with a Cobalt salt precipitate, wherein the Cobalt precipitate is filtered and dried to recover dried Cobalt salt; j) processing the second solution with oxygen at a predetermined pressure and temperature to produce a third solution and a Manganese salt precipitate, wherein the precipitate is filtered and dried to recover dried Manganese salt; k) mixing the third solution with alkali solution to form a fourth solution of pH value 14 with a Nickel salt precipitate, wherein the Nickel salt precipitate is filtered and dried to recover dried Nickel salt; l) heating the fourth solution to form a fifth solution and Sodium Sulphate precipitate, wherein the Sodium Sulphate precipitate is filtered and dried to recover dried sodium sulphate salt; and m) mixing the fifth solution with carbonates to obtain Lithium salts precipitate, wherein the precipitate is filtered washed with deionised water and then dried to recover dried Lithium Carbonate salt powder.

According to another aspect of the present invention, the process uses 1200-1900 PSI of air pressure air blower and a porous conveyor belt for cleaning and washing of the batteries, whereby the used water is gravity filtered for reuse.

According to another aspect of the present invention, the batteries are crushed to a particle size in the range of 2-8 mm.

According to another aspect of the present invention, the organic electrolyte material is acetonitrile (ACN).

According to another aspect of the present invention, the non-magnetic battery material containing plastic and black mass are baked at 250-300° C. for 30 minutes.

According to another aspect of the present invention, the black mass dissolved in the Lithium contained solution is filtered using a filter cloth with pore sizes ranging from 5-25 m microns.

According to another aspect of the present invention, the Lithium contained solution is heated at 85° C.-95° C. for 2.5-3 hours to obtain Lithium hydroxide powder.

According to another aspect of the present invention, the black mass is acid leached using an acid of concentration 10-80% w/v, wherein the acid is selected from a group consisting of H2SO4, HCl, HNO3 and combination thereof and an oxidising agent at a concentration of 3-10% w/v, wherein the oxidising agent is selected from a group consisting of H2O2, KMnO4 and combination thereof under continuous stirring at 400-800 rpm at a temperature 27-35° C. for 3-5 hours to obtain the first solution with the carbon precipitate, wherein the carbon precipitate is again treated with acid of concentration 10-40% w/v and 10-40% w/v of deionized water to extract second stage of first solution, the process is repeated with gradual decrease of acid concentration and gradual increase of deionized water till only carbon as a precipitate is left, then the carbon precipitate is dried at 70-120° C. to collect dried carbon powder.

According to another aspect of the present invention, the alkali solution mixed with the first solution is selected from the group consisting of bicarbonates, sulphates, hydroxide and combination thereof for 2-5 hours while the solution is continuously stirred at 400-800 rpm at temperature of about 27-35° C. and the filtered precipitate is dried at 70-120° C. in a hot air oven to recover the dried Cobalt salt.

According to another aspect of the present invention, the second solution is processed with bubbling oxygen at 475-525 kPa pressure and temperature of 28-330° C. for 0.5-2.3 hours, whereby the filtered Manganese salt precipitate is dried at 70-120° C. in a hot air oven to recover the dried Manganese salt.

According to another aspect of the present invention, the third solution mixed with the alkali solution is continuously stirred at 400-800 rpm and at an ambient temperature of about 27-35° C., whereby the filtered Nickel Salt precipitate is dried at 70-120° C. in a hot air oven to recover the dried Nickel Salt.

According to another aspect of the present invention, the fourth solution is heated at 60-70° C. for 2-5 hours to obtain sodium sulphate precipitates, whereby the sodium sulphate precipitate is oven dried at 70-120° C. for 1 hour to recover the dried sodium sulphate salt.

According to another aspect of the present invention, the carbonate mixed with the fifth solution is 7.5M Na2CO3 solution that is heated at 60-80° C. and continuously stirred for 2.5-3.5 hours, whereby the Lithium salt precipitate is oven dried at 70-120° C. for 1-3 hours to recover the dried lithium Carbonate Salt powder.

According to another aspect of the present invention, the dried Lithium hydroxide powder, dried Cobalt salt, dried Manganese salt, dried Nickel salt, dried Lithium salt are dissolved in deionised water and purified by selective absorption of respective ions using Ion-exchange resin and liquid-liquid extraction using organic solvent for beneficiation.

According to another aspect of the present invention, process of recovery of materials, from used energy storage devices, wherein the process comprises: a) air cleaning and then washing the energy storage devices with water, whereby the used water is gravity filtered for reuse; b) deep discharging the cleaned and washed storage devices in a deep discharging solution for 3-5 hours, then the deep discharged devices are air dried to remove surface moisture; c)
chopping and crushing said air dried devices in an airtight crusher at 50° C.-85° C. to obtain 2-8 mm sized crushed material and powdered black mass while collecting evaporated organic electrolyte material including acetonitrile (ACN) from the airtight crusher in an electrolyte collector using condensation; d) separating magnetic and non-magnetic materials from the crushed material using magnetic separator, whereas plastic, black mass, copper and aluminum are separated using eddy current technique and gravity air separation method; c) baking the remaining non-magnetic crushed material and the black mass at 250-300° C. for 30 minutes; f)
dispersing the baked material and the black mass in deionized (DI) water while stirring at 380-440 rpm to leach Lithium ions in the DI water to form a Lithium contained solution, separating floating non-magnetic materials over the solution using a strainer and then filtering the black mass that settles down due to gravity from the Lithium contained solution using a 5-25 microns filter cloth; g) heating the Lithium contained solution at a temperature 89-95° C. for 2-3 hours to obtain Lithium hydroxide powder; h) acid leaching the black mass with an acid of concentration 10-80% w/v, wherein the acid is selected from a group consisting of H2SO4, HCl, HNO3 and combination thereof, an oxidising agent of a concentration of 3-10% w/v, wherein the oxidising agent is selected from a group consisting of H2O2, KMnO4 and combination thereof and deionized water under continuous stirring at 400-800 rpm at a temperature 27-35° C. for 3-5 hours to obtain to obtain a brownish-orange colour solution and carbon particle as a precipitate, wherein the carbon precipitate is again treated with acid of concentration 10-40% w/v and 10-40% w/v of deionized water to extract second stage of brownish-orange colour solution, the process is repeated with gradual decrease of acid concentration and gradual increase of deionized water till only carbon as a precipitate is left, then the carbon precipitate is dried at 70-120° C. to be collected as dried carbon powder; i) mixing the brownish-orange colour solution with bicarbonates, sulphates, hydroxides or combination thereof with continuous stirring at 400-800 rpm at temperature of about 27-35° C. for 2-5 hours till the pH of the solution reaches 8, while the solution is converted to a yellowish orange colour solution with a Cobalt salt precipitate, wherein the precipitate is filtered and dried at 70-120° C. to recover dried Cobalt salt; j) processing the yellowish orange colour solution with bubbling oxygen at 475-525 kPa pressure and at a temperature 28-33° C. for 0.5-2.5 hours to obtain a pale yellow colour solution and a Manganese salt precipitate, wherein the precipitate is filtered and dried at 70-120° C. to recover dried Manganese salt; k) mixing the pale yellow colour solution with bicarbonates and/or sulphates and/or hydroxide or combination thereof with continuous stirring at 400-800 rpm at temperature of about 27-35° C. for 2-5 hours till the pH of the solution reaches 14, while the solution is converted to a creamish-yellow colour solution with a Nickel salt precipitate, wherein the precipitate is filtered and dried at 70-120° C. to recover dried Nickel salt; l) heating the creamish-yellow colour solution at about 60-70° C. till the solution is converted to a lithium-containing clear solution and sodium sulphate precipitate, wherein the precipitate is filtered and dried at 70-120° C. for 1-2 hour to recover dried sodium sulphate salt; m) mixing the lithium-containing clear solution with 7.5M Na2CO3 solution with continuous stirring at 400-800 rpm at a temperature of about 60-80° C. for 2.5-3.5 hours to obtain Lithium salts precipitate, wherein the precipitate is filtered washed with deionised water and then dried at 70-120° C. to recover dried Lithium Carbonate salt powder; and n) dissolving the dried Lithium hydroxide powder, dried Cobalt salt, dried Manganese salt, dried Nickel salt, dried Lithium Carbonate salt in deionised water and purifying by selective absorption of respective ions using Ion-exchange resin and liquid-liquid extraction using organic solvent for beneficiation.

According to another aspect of the present invention, the discharging solution selected from the group consisting of: a) a deionized water; b) a combination of deionized water and solution of degraded binders including PVDF, SBR and Carboxymethyl cellulose; c) a solution left out after recovery of the Cobalt salt, the Manganese salt, the Nickel salt and the Lithium salt from the black mass; and d) a solution left out after the beneficiation of respective ions from the Cobalt salt, the Manganese salt, the Nickel salt and the Lithium salt.

According to an embodiment of the present invention, energy storage devices, for example, lithium-ion batteries, sodium ion batteries, metal-air batteries and other energy storage devices are cleaned and washed. The lithium-ion batteries, sodium ion batteries, metal-air batteries and other energy storage devices and/or battery packs are placed on a porous conveyor belt adapted to pass through an air blower so as to remove or clean dust and other like material using 1200-1900 PSI of air pressure/atmospheric air pressure from the batteries, storage devices/packs and the dust so removed is collected in a dust collector. Further the cleaned batteries are then washed with the help of a water jet adapted to run over the conveyer belt, the water jet allows to wash the cleaned batteries to remove residual dust particles or the like. The water used during washing is collected and reused again by removing the dirt and particles using the gravity filtration method. The washed/cleaned batteries and/or energy storage packs are subjected to a deep discharge process. The Lithium batteries are fully discharged by immersing the same in a discharging solution for 4-5 hours. Without limitation, the discharging solution is deionized (DI) water or a combination of DI water and solution of degraded binders such as PVDF, SBR, Carboxymethyl cellulose, or a mixture of sodium/potassium or other relevant salts extracted from the black mass obtained after filtering dissolved Lithium from the black mass as described herein below.

According to another embodiment of the present invention, the washed, cleaned and fully discharged batteries are air dried to remove surface moisture and then crushed in an airtight crusher to a particle size in the range of 2-8 mm, wherein according to an exemplary embodiment, the washed, cleaned and fully discharged batteries are fed to an airtight hopper or a hammer mill/shredder/crusher operating at low RPM (revolutions per minute), preferably 1400-1600 rpm, in order to perform chopping and crushing operation internal stress is released while the batteries are shredded/chopped and crushed properly to obtain crushed material of the desired particle size. The crushed, shredded battery material consist of magnetic/ferrous materials and non-magnetic/non-ferrous materials which is subjected to the step of sorting. The organic electrolyte material like acetonitrile (ACN) evaporates, during crushing process, at a temperature of about 50° C.-85° C., but is collected back from the airtight crusher in an electrolyte collector using low temperature condensation. The organic electrolyte so collected is reused as an electrolyte as and when required.

According to another embodiment of the present invention, the non-magnetic/non-ferrous and magnetic/ferrous materials are separated using magnetic separator. The magnetic separator sorts/separates magnetic materials such as steel casing and iron from non-magnetic materials. The separated magnetic materials are collected in a collector bag. The non-magnetic battery materials such as aluminum, copper, plastics, and black mass (anode and cathode active materials) are separated using Eddy current separation technique to separate copper and aluminum from non-magnetic battery materials. The material so obtained is further subjected to the gravity air separation process to separate copper and aluminum on the basis of density. The separated copper and aluminum are collected into separate containers.

According to another embodiment of the present invention, the remaining non-magnetic battery material containing plastic and black mass (combination of active cathode and anode material) is subjected to baking at 250-300° C. for 30 minutes, thereafter the baked plastic and black mass undergoes water-soaking treatment. The material was dispersed into a first reactor containing Deionized (DI) water and stirred properly at an RPM of about 380-440 to facilitate leaching of lithium-ions. In this manner about 90-95% lithium is leached out in the DI water. The black mass settles down at the bottom due to gravity and plastic waste and separators float over the water surface. The plastic waste and separators are separated with the help of a strainer/sieve. The plastic waste so separated is then dried at room temperature ranging from 25° C. to 35° C. and collected into a plastic collector bag. Subsequently dissolved lithium and black mass are separated. Gravity filtration technique is used to separate the black mass from dissolved lithium solution using a filter cloth with pore sizes ranging from 5-25 m microns.

According to another embodiment of the present invention, the leached lithium solution is subjected to heating at a temperature in a range of 89° C.-95° C. for 2.5-3 hours in a second reactor to precipitate the Lithium metal salt. The white colour Lithium hydroxide powder is obtained at the bottom of the second reactor. Further mixing the obtained Lithium salt in deionised water and purifying by selective absorption of Lithium ions using Ion-exchange resin and organic solvent-based Liquid-liquid extraction for beneficiation.

According to another embodiment of the process of the present invention, the black mass is subjected to Acid leaching process for extraction of other cathode active material salts such as Nickel, Manganese, Cobalt, etc. For this purpose, required amount of black mass is put into a third reactor for the further leaching process. The black mass is leached with slow and continuous addition of an acid of concentration 10-80% w/v and an oxidising agent at a concentration of 3-10% w/v, wherein the acid is selected from the group comprising but not limited to H2SO4, HCl, HNO3 and/or combination thereof and oxidising agent is selected from the group comprising but not limited to H2O2, KMnO4 and/or combination thereof. Further the desired volume of acid and oxidising agents is added under continuous stirring at 400-800 rpm at ambient temperature of about 27-35° C. for 3-5 hours so as to obtain a homogenous brownish-orange colour solution and carbon particle mixture. The mixture so obtained is then filtered via gravity separation and the residue left is again treated with acid of concentration 10-40% w/v and 10-40% w/v of deionized water to extract second stage of brownish-orange colour solution therefrom, the process is repeated with gradual decrease of acid concentration and gradual increase of deionized water till only carbon as a residue/precipitate is left. Then the carbon as a precipitate is dried at 70-120° C. to be collected as dried carbon powder, wherein the recovered dried carbon powder is ready for use as an anode material for energy storage devices manufacturing.

According to another embodiment of the present invention, the brownish-orange colour leached solution filtered out from the third reactor is transferred into a fourth reactor using a staircase gravity transfer technique. The solution is slowly mixed with bicarbonates, sulphates, hydroxide and/or the combination thereof for 2-5 hours till the pH value of the solution reaches 8, while the solution is continuously stirred at 400-800 rpm at temperature of about 27-35° C. The solution is then filtered, using a press filter or the like to separate a yellowish orange colour leached solution and a precipitate, wherein the filtered precipitate is dried at 70-120° C. in a hot air oven or the like so as to extract/recover Cobalt salt. Further mixing the obtained Cobalt salt in deionised water and purifying by selective absorption of Cobalt ions using Ion-exchange resin and organic solvent-based Liquid-liquid extraction for beneficiation.

According to another embodiment of the present invention, the yellowish orange colour leached solution filtered out from the fourth reactor is transferred into a fifth reactor and is processed by bubbling oxygen in the leach solution at 475-525 kPa pressure preferably 500 kPa and at 28-33° C. for 0.5-2.3 hrs. The solution, after bubbling process, is filtered using a press filter or the like to separate a pale yellow colour leached solution and a precipitate. The filtered precipitate obtained from the fifth reactor is then dried at 70-120° C. in a hot air oven to extract/recover Manganese salt. Further mixing the obtained Manganese salt in deionised water and purifying by selective absorption of Manganese ions using Ion-exchange resin and organic solvent-based Liquid-liquid extraction for beneficiation.

According to another embodiment of the present invention, the pale yellow colour leached solution filtered out from the fifth reactor is transferred into a sixth reactor and bicarbonates and/or sulphates and/or hydroxide and/or their combination thereof is added steadily for 2-5 hours till the pH of the solution reaches 14, while the solution is continuously stirred at 400-800 rpm and at an ambient temperature of about 27-35° C. The mixture so obtained is then filtered using a press filter or the like to separate a creamish-yellow colour leached solution and a precipitate. The filtered precipitate obtained from the sixth reactor is then dried at 70-120° C. in a hot air oven to extract/recover Nickel Salt. Further mixing the obtained Nickel salt in deionised and purifying by selective absorption of Nickel ions using Ion-exchange resin and organic solvent based Liquid-liquid extraction for beneficiation.

According to another embodiment of the present invention, the creamish-yellow colour solution from the above process is heated in a seventh reactor at about 60-70° C. for predetermined time till white colour sodium sulphate precipitates formed in the solution. The solution is then filtered using gravity separation filtration technique to separate the white precipitated sodium sulphate and lithium-containing clear solution. The white precipitate sodium sulphate is oven dried at about 70-120° C. for 1-2 hours to extract/recover sodium sulphate salt.

According to another embodiment of the present invention, the lithium-containing clear solution obtained from the above step is then heated in a eighth reactor at a temperature of about 60-80° C. preferably at 72° C. with slow mixing of 7.5M Na2CO3 solution to the above solution continuously stirred and mixing for 2.5-3.5 hours from the formation of white precipitate to ensure proper mixing and complete precipitation of Lithium salts. The solution is then filtered by press filter technique or the like to separate white and clear filtrates/precipitates. The white colour filtrate is washed with DI (deionised) water and then dried at 70-120° C. and for 1-3 hours to extract/recover pure Lithium Carbonate Salt powder. Further mixing the obtained Lithium salt in deionised water and purifying by selective absorption of Lithium ions using Ion-exchange resin and organic solvent based Liquid-liquid extraction for beneficiation.

According to another embodiment of the present invention, the dried Lithium hydroxide powder, dried Cobalt salt, dried Manganese salt, dried Nickel salt, dried Lithium salt are dissolved in deionised water and purified by selective absorption of respective ions using Ion-exchange resin and liquid-liquid extraction using organic solvent for beneficiation.

According to another embodiment of the present invention, the discharging solution selected from the group consisting of: a) a deionized water; b) a combination of deionized water and solution of degraded binders including PVDF, SBR and Carboxymethyl cellulose; c) a solution left out after recovery of the Cobalt salt, the Manganese salt, the Nickel salt and the Lithium salt from the black mass; and d) a solution left out after beneficiation of respective ions from the Cobalt salt, the Manganese salt, the Nickel salt and the Lithium salt.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A process of recovery of materials from used batteries, the process comprising:
air cleaning and washing the batteries with water;
deep discharging the cleaned and washed batteries in a deep discharging solution and air drying the deep discharged batteries dried to remove surface moisture;
chopping and crushing the deep discharged batteries in an airtight crusher at 50° C.-85° C. to obtain crushed material, powdered black mass, and a volatile organic electrolyte material that is collected in an electrolyte collector by condensation;
separating magnetic materials, non-magnetic materials, copper, and aluminum from the crushed material;
baking a remaining non-magnetic crushed material in the crushed material and the powdered black mass;
dispersing the baked remaining non-magnetic crushed material and the powdered black mass in deionized water to form a Lithium contained solution, separating floating plastic wastes over the solution and then filtering the dispersed powdered black mass from the Lithium contained solution;
heating the Lithium contained solution to obtain Lithium hydroxide powder;
acid leaching the powdered black mass with an acid, an oxidizing agent, and deionized water to obtain a first solution with carbon precipitate, wherein the carbon precipitate is dried to recover carbon powder;
mixing the first solution with alkali solution to form a second solution of pH value 8 with a Cobalt salt precipitate, wherein the Cobalt salt precipitate is filtered and dried to recover dried Cobalt salt;
processing the second solution with oxygen at a determined pressure and temperature to produce a third solution and a Manganese salt precipitate, wherein the Manganese salt precipitate is filtered and dried to recover dried Manganese salt;
mixing the third solution with alkali solution to form a fourth solution of pH value 14 with a Nickel salt precipitate, wherein the Nickel salt precipitate is filtered and dried to recover dried Nickel salt;
heating the fourth solution to form a fifth solution and Sodium Sulphate precipitate, wherein the Sodium Sulphate precipitate is filtered and dried to recover dried sodium sulphate salt; and
mixing the fifth solution with carbonates to obtain Lithium salts precipitate, wherein the Lithium salts precipitate is filtered washed with deionized-deionised water and then dried to recover dried Lithium Carbonate salt powder.

2. The process of recovery of materials from used batteries according to claim 1, wherein 1200-1900 PSI of air pressure air blower and a porous conveyor belt is used for cleaning and washing of the batteries, and wherein used water is gravity filtered for reuse.

3. The process of recovery of materials from used batteries according to claim 1, wherein the discharging solution is selected from the group consisting of:
the deionized water,
a combination of deionized water and solution of degraded binders including PVDF, SBR and Carboxymethyl cellulose,
a solution left out after recovery of the dried Cobalt salt, the dried Manganese salt, the dried Nickel salt, and the dried Lithium Carbonate salt powder from the powdered black mass, and
a solution left out after beneficiation of respective ions from the dried Cobalt salt, the dried Manganese salt, the dried Nickel salt, and the dried Lithium Carbonate salt powder.

4. The process of recovery of materials from used batteries according to claim 1, wherein the batteries are crushed to a particle size in a range of 2-8 mm.

5. The process of recovery of materials from used batteries according to claim 1, wherein the volatile organic electrolyte material is acetonitrile (ACN).

6. The process of recovery of materials from used batteries according to claim 1, wherein a non-magnetic battery material containing plastic and the powdered black mass is baked at 250-300° C. for 30 minutes.

7. The process of recovery of materials from used batteries according to claim 1, wherein the powdered black mass dissolved in the Lithium contained solution is filtered using a filter cloth with pore sizes ranging from 5-25 m microns.

8. The process of recovery of materials from used batteries according to claim 1, wherein the Lithium contained solution is heated at 85° C.-95° C. for 2.5-3 hours to obtain the Lithium hydroxide powder.

9. The process of recovery of materials from used batteries according to claim 1, wherein
the powdered black mass is acid leached using the acid of concentration 10-80% w/v,
the acid is selected from a group consisting of H₂SO₄, HCl, HNO₃, and combination thereof and an oxidizing agent at a concentration of 3-10% w/v,
the oxidizing agent is selected from a group consisting of H₂O₂, KMnO₄, and combination thereof under continuous stirring at 400-800 rpm at a temperature 27-35° C. for 3-5 hours to obtain the first solution with the carbon precipitate,
the carbon precipitate is again treated with acid of concentration 10-40% w/v and 10-40% w/v of deionized water to extract second stage of the first solution, and
the process is repeated with gradual decrease of acid concentration and gradual increase of deionized water till only carbon as a precipitate is left, then the carbon precipitate is dried at 70-120° C. to be collected as dried carbon powder.

10. The process of recovery of materials from used batteries according to claim 1, wherein the alkali solution mixed with the first solution is selected from the group consisting of bicarbonates, sulphates, hydroxide, and combination thereof for 2-5 hours while the solution is continuously stirred at 400-800 rpm at temperature of about 27-35° C. and the filtered precipitate is dried at 70-120° C. in a hot air oven to recover the dried Cobalt salt.

11. The process of recovery of materials from used batteries according to claim 1, wherein the second solution is processed with bubbling oxygen at 475-525 kPa pressure and a temperature of 28-33° C. for 0.5-2.3 hours, and wherein the filtered Manganese salt precipitate is dried at 70-120° C. in a hot air oven to recover the dried Manganese salt.

12. The process of recovery of materials from used batteries according to claim 1, wherein the third solution mixed with the alkali solution is continuously stirred at 400-800 rpm and at an ambient temperature of about 27-35° C., and wherein the filtered Nickel Salt precipitate is dried at 70-120° C. in a hot air oven to recover the dried Nickel Salt.

13. The process of recovery of materials from used batteries according to claim 1, wherein the fourth solution is heated at 60-70° C. for 2-5 hours to obtain sodium sulphate precipitates, wherein the sodium sulphate precipitate is oven dried at 70-120° C. for 1 hour to recover the dried sodium sulphate salt.

14. The process of recovery of materials from used batteries according to claim 1, wherein the carbonates mixed with the fifth solution is 7.5M Na₂CO₃ solution that is heated at 60-80° C. and continuously stirred for 2.5-3.5 hours, wherein the Lithium salt precipitate is oven dried at 70-120° C. for 1-3 hours to recover the dried lithium Carbonate Salt powder.

15. The process of recovery of materials from used batteries according to claim 1, wherein dried Lithium hydroxide powder, the dried Cobalt salt, the dried Manganese salt, the dried Nickel salt, dried Lithium salt are dissolved in the deionized water and purified by selective absorption of respective ions using Ion-exchange resin and liquid-liquid extraction using organic solvent for beneficiation.

16. A process of recovery of materials, from used energy storage devices, the process comprising:
air cleaning and washing the energy storage devices with water, whereby the water is gravity filtered for reuse;
deep discharging the cleaned and washed energy storage devices in a deep discharging solution for 3-5 hours, wherein the deep discharged energy storage devices are air dried to remove surface moisture;
chopping and crushing the air dried energy storage devices in an airtight crusher at 50° C.-85° C. to obtain 2-8 mm sized crushed material and powdered black mass while collecting evaporated organic electrolyte material including acetonitrile (ACN) from the airtight crusher in an electrolyte collector using condensation;
separating magnetic and non-magnetic materials from the crushed material using magnetic separator, whereas plastic, the powdered black mass, copper, and aluminum are separated using eddy current technique and gravity air separation method;
baking a remaining non-magnetic crushed material in the crushed material and the powdered black mass at 250-300° C. for 30 minutes;
dispersing the baked remaining non-magnetic crushed material and the powdered black mass in deionized (DI) water while stirring at 380-440 rpm to leach Lithium ions in the DI water to form a Lithium contained solution,
separating floating non-magnetic materials over the solution using a strainer and then filtering the powdered black mass that settles down due to gravity from the Lithium contained solution using a 5-25 microns filter cloth;
heating the Lithium contained solution at a temperature 89-95° C. for 2-3 hours to obtain Lithium hydroxide powder;
acid leaching the powdered black mass with an acid of concentration 10-80% w/v, wherein the acid is selected from a group consisting of H₂SO₄, HCl, HNO₃, and a combination thereof, an oxidizing agent of a concentration of 3-10% w/v, wherein
the oxidizing agent is selected from a group consisting of H₂O₂, KMnO₄ and a combination thereof and deionized water under continuous stirring at 400-800 rpm at a temperature 27-35° C. for 3-5 hours to obtain to obtain a brownish-orange color solution and carbon particle as a precipitate,
the carbon precipitate is again treated with acid of concentration 10-40% w/v and 10-40% w/v of deionized water to extract second stage of brownish-orange color solution, and
the process is repeated with gradual decrease of acid concentration and gradual increase of deionized water till only carbon as a precipitate is left, then the carbon precipitate is dried at 70-120° C. to be collected as dried carbon powder;
mixing the brownish-orange color solution with bicarbonates, sulphates, hydroxides, or combination thereof with continuous stirring at 400-800 rpm at temperature of about 27-35° C. for 2-5 hours till the pH of the solution reaches 8, while the solution is converted to a yellowish orange color solution with a Cobalt salt precipitate, wherein the precipitate is filtered and dried at 70-120° C. to recover dried Cobalt salt;
processing the yellowish orange color solution with bubbling oxygen at 475-525 kPa pressure and at a temperature 28-33° C. for 0.5-2.5 hours to obtain a pale yellow color solution and a Manganese salt precipitate, wherein the precipitate is filtered and dried at 70-120° C. to recover dried Manganese salt;
mixing the pale yellow color solution with bicarbonates and/or sulphates and/or hydroxide or combination thereof with continuous stirring at 400-800 rpm at temperature of about 27-35° C. for 2-5 hours till the pH of the solution reaches 14, while the solution is converted to a creamish-yellow color solution with a Nickel salt precipitate, wherein the precipitate is filtered and dried at 70-120° C. to recover dried Nickel salt;
heating the creamish-yellow color solution at about 60-70° C. till the solution is converted to a lithium-containing clear solution and sodium sulphate precipitate, wherein the precipitate is filtered and dried at 70-120° C. for 1-2 hour to recover dried sodium sulphate salt;
mixing the lithium-containing clear solution with 7.5M Na₂CO₃ solution with continuous stirring at 400-800 rpm at a temperature of about 60-80° C. for 2.5-3.5 hours to obtain Lithium salts precipitate, wherein the precipitate is filtered washed with deionized water and then dried at 70-120° C. to recover dried Lithium Carbonate salt powder; and
dissolving dried Lithium hydroxide powder, the dried Cobalt salt, the dried Manganese salt, the dried Nickel salt, dried Lithium Carbonate salt in the deionized water and purifying by selective absorption of respective ions using Ion-exchange resin and liquid-liquid extraction using organic solvent for beneficiation.

17. The process of recovery of materials from the used energy storage devices according to claim 16, wherein the discharging solution selected from the group consisting of:
the deionized water;
a combination of deionized water and solution of degraded binders including PVDF, SBR and Carboxymethyl cellulose;
a solution left out after recovery of the dried Cobalt salt, the dried Manganese salt, the dried Nickel salt, and the dried Lithium Carbonate salt powder from the powdered black mass; and
a solution left out after the beneficiation of respective ions from the dried Cobalt salt, the dried Manganese salt, the dried Nickel salt, and the dried Lithium Carbonate salt powder.
